(19) United States
(12) Patent Application Publication
(10) Pub. No.: US 2006/0251805 A1
(43) Pub. Date: Nov. 9, 2006

(54) Combination hybrid kinetic spray and consolidation processes

(76) Inventors: Dawn White, Ann Arbor, MI (US); Ken E. Johnson, South Lyon, MI (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/345,475

(22) Filed: Feb. 1, 2006

Related U.S. Application Data
(60) Provisional application No. 60/649,031, filed on Feb. 1, 2005.

(51) Int. Cl. B05D 3/00; B23K 20/10; A47J 36/02; B32B 37/24

(52) U.S. Cl. 427/189; 156/73.1; 156/62.2; 427/600; 427/191; 228/101; 228/110.1

(57) ABSTRACT

Solid-state bonding technologies are combined with other solid-state consolidation techniques to create new processes, applications, and structures. One embodiment uses metal or plastic spraying techniques with the intention of only partially bonding the droplets to the substrate, while employing a secondary process such as ultrasonic and/or electrical resistance consolidation to achieve complete agglomeration and eliminate porosity. This opens new opportunities with regard to materials, powder types, applications, and automated machinery. Some examples of these hybrids and their applications are provided, however, along with the identification of other combinations.

### REFERENCE TO RELATED APPLICATION

This application claims priority from U.S. Provisional Patent Application Ser. No. 60/649,031, filed Feb. 1, 2005, the entire content of which is incorporated herein by reference.

### FIELD OF THE INVENTION

This invention relates generally to additive manufacturing and, in particular, to combinations of kinetic material spraying followed by droplet consolidation.

### BACKGROUND OF THE INVENTION

Ultrasonic consolidation is an additive manufacturing technology used to produce objects of any geometry from uniform, featureless feedstocks, such as tapes, sheets, wires, or droplets. There are a range of methods for accomplishing the metallurgical consolidation of the feedstocks via ultrasonic energy. These include, but are not limited to, spot consolidation, continuous rotary consolidation, plate-type consolidation, and so forth.

My U.S. Pat. No. 6,519,500, incorporated herein by reference, is directed to a system and a method of fabricating an object by adding material layers incrementally and consolidating the layers through the use of ultrasonic vibrations and pressure. The layers are placed in position to shape the object by a material feeding unit. The raw material may be provided in various forms, including flat sheets, segments of tape, strands of filament or single dots cut from a wire roll. The material may be metallic or plastic, and its composition may vary discontinuously or gradually from one layer to the next, creating a region of functionally gradient material. Plastic or metal matrix composite material feedstocks incorporating reinforcement materials of various compositions and geometries may also be used.

If excess material is applied due to the feedstock geometry employed, such material may be removed after each layer is bonded, or at the end of the process; that is after sufficient material has been consolidated to realize the final object. A variety of tools may be used for material removal, depending on composition and the target application, including knives, drilling or milling machines, laser cutting beams, or ultrasonic cutting tools.

The consolidation is effected by ultrasonic welding equipment, which includes an ultrasonic generator, a transducer, a booster and a head unit, also called a horn or sonotrode. Ultrasonic vibrations are transmitted through the sonotrode to the common contact surface between two or more adjacent layers, which may include layers next to each other on the same plane, and/or layers stacked on top of each other. The orientation of the sonotrode is preferably adjusted so that the direction of the ultrasonic vibrations is normal to the contact surface when consolidating layers of plastic material, and parallel to the contact surface when consolidating layers of metal.

The layers are fed sequentially and additively according to a layer-by-layer computer model description of the object, which is generated by a computer-aided design (CAD) system. The CAD system, which holds the layered description of the object, interfaces with a numerical controller, which in turn controls one or more actuators. The actuators impart motion in multiple directions, preferably three orthogonal directions, so that each layer of material is accurately placed in position and clamped under pressure. The actuators also guide the motion of the sonotrode, so that ultrasonic vibrations are transmitted in the direction required through the common contact surfaces of the layers undergoing consolidation.

Cold-metal powder spraying technology, on the other hand, involves the solid-state bonding of metal powders to each other or to a substrate by accelerating the powers to high speed. When these high-speed metal powders strike another metal surface, the oxide layers on both the powder and target are displaced, allowing atomically clean metal surfaces to come in contact with each other, and forming a solid state weld across the interface, as shown in FIG. 1. A significant amount of patent and scientific literature on various types of cold droplet acceleration and impingement technologies exists. Some applications of these processes to date include coating, bulk object fabrication, and so forth.

Cold-spraying technologies, like the more common hot-spray techniques such as arc spraying, rely on “splatting” of the accelerated powders to produce an agglomerated coating or bulk. Maximizing the mechanical properties of the agglomerate typically requires very high speed droplets in order to achieve sufficient plastic deformation in the powder to eliminate porosity as the powder layers accumulate. This places heavy design demands on the systems used to spray the powders and limits powder size, composition, and deposit rates etc.

Layer-by-layer direct printing processes have been developed by Sachs, et al., and licensed commercially for various applications. In addition, other single droplet generation and jetting techniques for producing and depositing liquid droplets to produce objects have been developed by various individuals and organizations. However, there remain major difficulties associated with producing accurate object geometries with approaches involving liquid metals such as those mentioned.

Ultrasonic object consolidation is process for layer-by-layer additive manufacturing whereby a featureless feedstock in the form of a tape, sheet, wire, or droplet is ultrasonically bonded to previously deposited material according to a CAD description of a desired object. However, it is necessary to ensure that a droplet type feedstock is located semi-permanently on the surface to which it is to be bonded ultrasonically or using electrical resistance.

### SUMMARY OF THE INVENTION

This invention broadly resides in combining solid-state bonding technologies with other solid-state consolidation techniques to create new processes, applications, and structures. One embodiment uses metal or plastic spraying techniques with the intention of only partially bonding the droplets to the substrate, while employing a secondary process such as ultrasonic and/or electrical resistance consolidation to achieve complete agglomeration and eliminate porosity. This opens new opportunities with regard to materials, powder types, applications, and automated machinery. Some examples of these hybrids and their applications are provided, however, along with the identification of other combinations.

### BRIEF DESCRIPTION OF THE DRAWINGS

FIG. 1 depicts a typical prior-art cold-spray technique;

FIG. 2A shows one or several layers of powder(s) are sprayed on to a surface, with the powders intentionally only partially agglomerated;

FIG. 2B illustrates a high-resistance interface for either ultrasonic or electrical energy; and

FIG. 2C shows how further bonding to appropriate region(s) leads to complete consolidation.

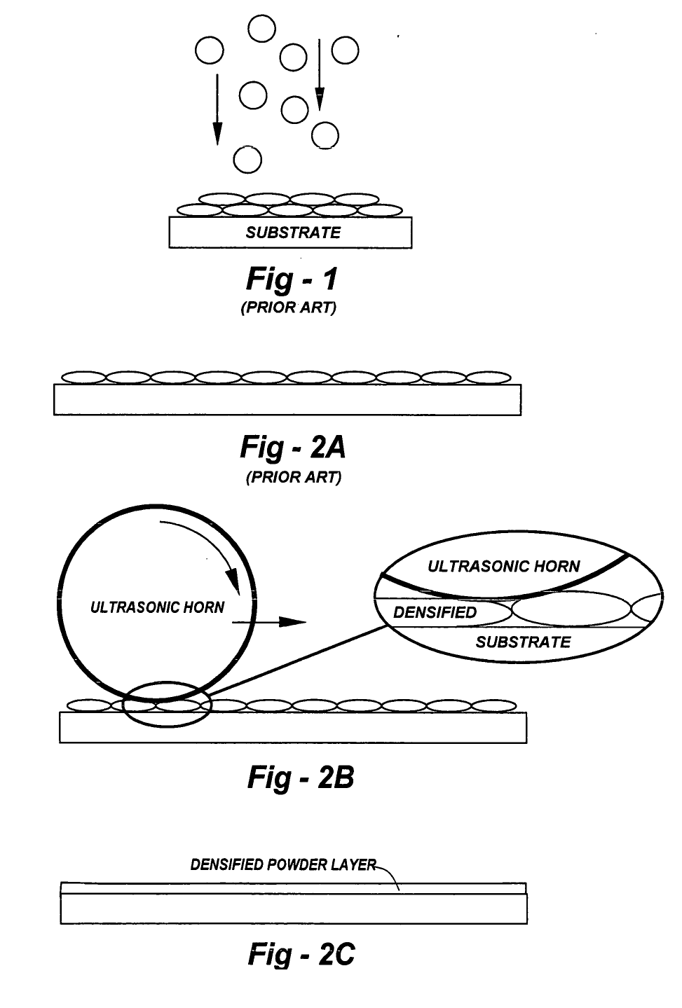

### DETAILED DESCRIPTION OF THE INVENTION

According to this invention, cold-spraying provides a convenient means of achieving such a “tack weld,” without requiring the presence of molten metal. In this embodiment, one or several layers of powder(s) are sprayed on to a surface, with the powders intentionally only partially agglomerated, as shown in FIG. 2A: The partially consolidated interface between the droplets and the substrate (or previously deposited material), even if does not produce fully dense layers, represents a high-resistance interface for either ultrasonic or electrical energy (FIG. 2B). As such, further bonding to the appropriate region(s) leads to complete consolidation (FIG. 2C).

This provides many advantages from an application point of view. For example, powders of varying composition can be applied in one or many layers. A wide area of powders can be applied or very small local regions. As result, functionally gradient materials can be produced using this method. The solid-state processing means that metallurgically incompatible powders can be applied and bonded without the difficulties such as immiscibility, segregation, brittle second phases, solidification cracking, etc. that typically plague such processes. Furthermore, the very high residual stresses and resulting distortion and sometimes cracking that are experienced in some liquid metal additive manufacturing processes are also eliminated.

Although the invention is presented primarily with metals in mind it is very important to note that in the case of secondary consolidation via ultrasonic energy, a plastic powder could be used. As with certain metals, such a plastic powder could be applied with either a hot or a cold process. The final consolidation would be as described for metals except that the ultrasonic energy will be imparted via perpendicular rather than lateral motion of the sonotrode with respect to the droplet layer(s). In addition, a metal/plastic composite layer with special properties could also be applied using the invention.

In the case of softer metals such as aluminum, copper, annealed stainless steels, brasses, etc., ultrasonic energy may suffice to fully consolidate the droplets. This source of energy is well suited to consolidation of most metals, and it is not the intention of the inventor to exclude any metals as unsuitable for the above-described process. However, in the case of higher strength materials, and those metals with relatively high electrical resistance, it may be advantageous to use electrical energy in place of, or in combination with, ultrasonic energy in order to completely consolidate a layer or layers of droplets partially attached through cold spraying.

The benefit of combining electrical resistance with ultrasonic energy in this case, is that the same partially consolidated droplet interface that presents a high-impedance acoustic interface, allowing ultrasonic energy to be active to produce a bond, also provides resistance to transmission of electrical energy. This high-resistance interface results in local heating, which lowers the strength of the material in the affected region, making the ultrasonic energy more effective at producing a bond. As a result the two energy types are well suited to be used in tandem in the presence of the faying surface geometries described above. Local heating produced by electrical resistance in the absence of ultrasonic energy in combination with a perpendicular applied force is also a possible means of accomplishing full consolidation of the droplets.

Although the concept of combining electrical resistance and ultrasonic energy as a means of producing an article via layered manufacturing using featureless feedstocks is presented here as a means of consolidated droplets applied to a surface via cold spraying, it is equally suited to other types of featureless feedstocks such as sheet, tape, wires, etc., which may be located on a surface via various material placement techniques, not limited to those described above.

We claim:

1. A method of producing a layered structure, comprising the steps of:
a) spraying droplets of material onto a surface; and
b) using a solid-state process to consolidate the droplets.

2. The method of claim 1, wherein the step of spraying uses a solid-state cold-spraying process.

3. The method of claim 1, wherein the step of spraying uses a solid-state hot-spraying process.

4. The method of claim 1, wherein the step of spraying uses a metal powder spray.

5. The method of claim 1, wherein the step of spraying uses a plastic powder spray.

6. The method of claim 1, wherein the step of spraying uses a spray containing more than one material.

7. The method of claim 1, wherein the solid-state process used to consolidate the droplets utilizes ultrasonic consolidation.

8. The method of claim 1, wherein the solid-state process used to consolidate the droplets utilizes electrical resistance.

9. The method of claim 1, wherein the solid-state process used to consolidate the droplets utilizes a combination of ultrasonic consolidation and electrical resistance.

10. The method of claim 1, further including the step of repeating steps a) and b) until a desired object is created.

11. The method of claim 10, wherein the desired object is provided as a CAD description.

12. A method of producing an object, comprising the steps of:
applying partially consolidated droplets to a surface using a cold spraying technique to hold them in place; and
using a secondary complete consolidation process to more fully agglomerate the droplets.

13. The method of claim 12, wherein partially consolidated droplets are uniform, non-uniform, or of varying size or composition.

14. The method of claim 12, wherein partially consolidated droplets are fully consolidated via ultrasonic energy excitation and/or local deformation.

15. The method of claim 12, wherein partially consolidated droplets are fully consolidated via electrical resistance heating and/or local deformation.

16. The method of claim 12, wherein partially consolidated droplets are fully consolidated via a combination of electrical resistance heating, ultrasonic excitation, and/or local deformation.

17. A method of producing an object or arbitrary geometry, comprising the steps of:
consolidating layers of metal composed of featureless sheets, tapes, wires, or droplets; and
combining ultrasonic excitation and bonding and/or electrical resistance joining techniques to fully consolidate the featureless sheets, tapes, wires, or droplets.
